(19) United States
(12) Patent Application Publication
(10) Pub. No.: US 2020/0364907 A1
(43) Pub. Date: Nov. 19, 2020

(54) SYSTEMS AND METHODS FOR COMPRESSING 3D PRINTER DATA

(71) Applicant: DESKTOP METAL, INC., Burlington, MA (US)

(72) Inventor: Ratko V. Tomic, Lexington, MA (US)

(21) Appl. No.: 16/413,048

(22) Filed: May 15, 2019

(51) Int. Cl. G06T 9/40; G06K 15/12; G06K 15/02; B33Y 50/02; B29C 64/393

(52) U.S. Cl. CPC G06T 9/40; G06K 15/1276; B29C 64/393; G06K 15/1822; B33Y 50/02; G06K 15/128

(57) ABSTRACT

Two dimensional layer data representing successive layers of objects to be 3D-printed is reduced in size to reduce storage requirements and transmission bottlenecks that increase costs and reduce the efficiency of 3D printers, by encoding the layer data in accordance with systems and methods that take into account 2D and 3D regularities inherent in such layer data, and allow for efficient and lossless reconstruction of the original 3D layer data when it is needed by the 3D printer.

### FIELD OF THE DISCLOSURE

This disclosure describes novel technological improvements to the field of additive manufacturing, and specifically to the field of 3D printing of objects by a 3D printer. In particular, this disclosure is directed to novel systems and methods for reducing the large quantity of 3D data that typically has to be sent to a 3D printer during the printing process, thereby making 3D printing systems and processes more efficient, faster and less costly.

### BACKGROUND OF THE DISCLOSURE

Over the past several decades, there has been a revolution in the technology for manufacturing objects (e.g., made from plastics, metals and other materials) that has been fueled by the unique capabilities of 3D printers. Because of their versatility, various types of 3D printers are becoming a growing percentage of the parts manufacturing market, providing not only the ability for parts designers to rapidly prototype custom designs, but also permitting factories to mass produce finalized designs of many objects (also referred to herein as “parts”) at a cost competitive with and sometimes more economical than conventional manufacturing processes.

Not too long ago, 3D printers were primarily used by hobbyists to make small objects out of various thermoplastic materials. Today, 3D printers can not only make objects or parts out of a wide array of thermoplastics, but also out of metals and various other materials. Significantly, 3D printers can do so in ways that eliminate or significantly reduce the need for conventional machining or other finishing steps typically required to fabricate a finished part using conventional manufacturing technology. 3D printers are therefore increasingly being used in manufacturing to both prototype and manufacture a wide array of objects that would be more costly to manufacture by other means. Often these objects have features that would be nearly impossible to otherwise fabricate without intricate and costly machining. By way of example, 3D printing is already being used by the aircraft industry to make highly specialized turbine engine parts. It is widely anticipated that the market share of objects made by 3D printing will continue to grow at a fast pace.

3D printers are a form of “additive manufacturing,” as opposed to “subtractive” manufacturing in which an object is made by removing material using conventional machining processes. In contrast, 3D printers work by adding layer by layer of materials to manufacture an object from the bottom up. The layers are added in accordance with digital data provided to the 3D printer that instructs the 3D printer where to deposit material for each layer. This 3D layer data corresponds to a bitmap that defines the multiple cross-sectional layers of the object to be printed.

During an exemplary 3D printing process, the data for each layer is used to provide instructions to one or more print heads that move in an x-y plane to deposit a material (e.g., plastic or metal) at appropriate locations to form each cross-sectional layer. In such 3D systems, a 3D object may be built up layer-by-layer by the print heads extruding or otherwise forming various materials at locations defined by the data for each layer. In another exemplary 3D printing process such as binder jetting, a layer of powder material may first be deposited and the data for each layer may define the locations where a binder should be deposited onto the powder layer to consolidate the power particles, thereby forming a layer of an object.

These 3D printing systems and processes may be thought of as being a 3D analog of an inkjet printer, which deposits a single layer of ink at particular locations to form an alphanumeric or graphic character, under the control of a computer. In a 3D printer however, hundreds or thousands of such layers, formed from plastics, metals or other materials, are deposited on top of each other to form a 3D object.

Generally, there have been two approaches used to represent the layer data required for 3D printing, which starts with a 3D mathematical model of the object to be printing. In a first exemplary approach, the data provided to the printer may consist of so-called “G-eodes” that instruct the printer to move the print heads at a particular rate along designated coordinates to, for example, extrude material along a specified path. Before the advent of 3D printing, G-codes were developed and widely used to control the operation of numerically-controlled (NC) machine tools, to instruct the tools to move along particular paths to complete a machining operation. Comparably, in 3D printing, the data for controlling a 3D printer may be provided as G-code data that defines the paths along which one or more 3D print heads should move to deposit each layer.

In a second approach, each layer is represented by a two-dimensional digital bitmap made up of millions of “pixels.” Data for thousands of such layers may be needed to fully define the structure of a 3D part.

The amount of such raw layer data for even a small object or part to be printed is generally very large, typically ranging from hundreds of MB (when providing line data represented by G-codes) to several TB or more (when providing 2D bitmap data for each layer). The large sizes of such files are a problem for network transmission to the printer as well as for local storage on the printer.

It has therefore been a practice in the prior art to use general-purpose digital file compressors (e.g. variants of the popular “zip” or “gzip” compression formats) to compress the layer data before it is transmitted along a network to the 3D printer and/or before the data may be locally stored in the 3D printer.

However, general-purpose file compressors do not perform effective compression on the layer data. The compressed files still result in, for example, file sizes in the tens of MB for 2D line data and several GB for 2D layer data in the form of images, even for parts that have small dimensions. Since the layer data may be sent to 3D printers over computer networks where the data has to be stored prior to printing, the increased storage costs and longer transmission times become major technological problems and bottlenecks. The same problems arise when uncompressed 3D layer data is stored locally within the 3D printer system during printing.

These problems and bottlenecks are being exacerbated as 3D printers are becoming more widely used in mass production environments where they are expected to produce larger and larger objects having more and more layers, at higher and higher speeds.

Accordingly, there is a present and growing need for systems and methods that can reduce the amount of data required by 3D printers to fabricate parts, which are becoming larger and more complicated, in order to reduce costs, allow more print jobs to be cached locally on the printer and increase production speeds. At the same time, there is a need to reduce latencies incurred by networks when transmitting large amounts of layer data to a 3D printer, and the attendant high storage requirements, both at the network side and locally at the printer location. As explained further below, such problems and bottlenecks can be significantly reduced or obviated by using the methods and systems disclosed herein.

### BRIEF SUMMARY OF THE DISCLOSURE

A major weakness of using prior art, general-purpose compressors such as “zip” and “gzip” for compressing 3D layer data is that their algorithms are modeled to only identify and compress common substrings in a 1-dimensional stream of data bytes. This modeling does not take into account the fact that the patterns and regularities found in the layer data sent to 3D printers are spread out over 2 and 3 dimensions. Hence the general-purpose compressors miss most of the regularities intrinsic to 3D printer layer data, and they result in highly suboptimal compression of such 3D layer data.

The instant disclosure addresses this problem by describing systems and methods that take into account and efficiently compress the 2D and 3D layer data regularities that arise from the nature of 3D printer data, and translate them into 1D byte stream regularities that may then be further compressed by using entropy coding in a final step. Significantly, all of the data compression must be done in a lossless manner such that the exact original layer data can be fully reconstructed before 3D printing is performed, without any loss in quality or resolution.

The primary 3D regularity in 3D layer data arises from the fact that adjacent layers may be incrementally different, but generally are very similar to each other. This similarity is enforced by the fact that often, each layer is built so as to have a supporting structure under it. The compression methods and systems disclosed herein account for such layer to layer similarities by encoding only the differences between layers (except, of course, for the first layer).

The most important 2D regularities in the layer data arise from the geometries of the printed parts, and the need for spacing between the parts. Hence, in a 2D layer, adjacent rows and columns will typically exhibit high similarity. The compression methods and systems disclosed herein account for such 2D regularities by further encoding only the differences between the scan rows and/or columns.

Further, the 2D cross sections represented by the layer data will typically exhibit high clustering of regions where material is to be deposited by the 3D print head, with empty spaces in between those regions. The methods and systems disclosed herein account for this clustering and efficiently compress each layer of data by using quadtree tiling methods as part of the compression process. The quadtree technique effectively tiles a layer into variably-sized squares that hierarchically separate and distinguish between those regions of a layer that will be filled in with material (e.g., pixel value=1), and those regions that only have empty spaces (e.g., pixel value=0).

As explained below, the output of the quadtree tiling process provides a bitmap layout of the tiling followed by the content of only non-empty tiles (i.e., tiles having at least one non-zero pixel value). As also described further herein, any empty tiles are then implicitly and efficiently coded since they require no additional data besides the tiling bitmap layout for reconstruction of the original uncompressed data by the decoder.

By combining the foregoing techniques to account for both the 2D and 3D regularities present in each layer of data, the layer data may be efficiently converted and compressed into a one-dimensional highly “sparse” stream of bytes (i.e., consisting mostly of pixels with value “0”). This highly sparse stream may then be compressed using a general-purpose compressor that is well suited for compressing this type of sparse 1D stream, such as the widely used BZIP encoder.

The inventor has empirically measured and verified that by using the methods and systems described herein and in more detail below, the resulting data output size of the compressed file will typically be 10-30 times smaller than the output size obtained from using prior art compression techniques that are presently being used to compress 3D layer data.

In addition to significantly reducing the output file size beyond what is possible with existing prior art approaches, it is also important to maintain sufficiently fast encoding and decoding speeds. Hence the efficiency of compression needs to be balanced with the need to economize on the required processing time. The processing time is particularly important when decoding compressed layer data to convert it to its original uncompressed state. Since 3D printing is done under mechanically determined time constraints, the decoded data for each layer has to be made available to the 3D printer sufficiently in advance of the next phase in the layer printing process, which proceeds as a continuous series of tightly timed mechanical steps.

The methods and systems disclosed herein not only significantly reduce the compressed file sizes that need to be transmitted and or stored, but also provide fast encoding and decoding times commensurate with the requirements of high-speed 3D printers.

By way of example, using the methods and systems disclosed herein, it has been confirmed, that for a layer size of 16K×16K pixels per layer (e.g., 30-70 MB of raw data per layer), an encoder operating in accordance with this disclosure can encode/compress approximately 30 layers per second, and a decoder constructed in accordance with this disclosure can decode/decompress approximately 70 layers per second, resulting in extremely fast processing times compared to what is achievable with prior art encoders/decoders.

### BRIEF DESCRIPTION OF THE DRAWINGS

The features and advantages of this disclosure can be more fully understood with reference to the following detailed description, considered in conjunction with the accompanying Figures, wherein:

FIG. 1 depicts an exemplary block diagram of a 3D printer system in which the disclosed methods and systems would be implement.

FIG. 2 illustrates the key phases described herein for efficiently compressing layer data required by a 3D printer to print on object.

FIG. 3A illustratively depicts exemplary data that represents a layer (L1) of a 3D object

FIG. 3B illustratively depicts exemplary data that represents another layer (L2) of a 3D object that is adjacent to the layer L1.

FIG. 3C illustratively depicts the result RX1 of performing XOR operations on two adjacent rows of the layer L1 data shown in FIG. 3A.

FIG. 3D illustratively depicts the result RX2 of performing XOR operations on two adjacent rows of the layer L2 data shown in FIG. 3B.

FIG. 4A illustratively depicts the result LX12 of performing XOR operations on corresponding pixels of L1 and L2

FIG. 4B illustratively depicts the result LRX12 of performing XOR operations on adjacent rows of LX12 to form bit map LRX12.

FIG. 5A illustratively depicts how two-level quadtree tiling would be applied the exemplary bit map LRX12 shown in FIG. 4B.

FIG. 5B illustratively depicts a quadtree bitmap the results from the application of two-level quadtree tiling to the LRX12 bit map of FIG. 5A.

FIG. 5C illustratively depicts the corresponding tile array that results from applying two-level quadtree tiling to the LRX12 bit map of FIG. 5A.

FIG. 6A illustratively depicts an exemplary tile array as reconstructed during the decompression (or decoding) process, where each tile is shown in flattened format.

FIG. 6B illustratively depicts the first two tiles of the reconstructed tile array in matrix format.

FIGS. 6C and 6D illustrate how the upper left hand portions of the LRX12 bit map (FIG. 6C) may be reconstructed during the decoding process by using corresponding portions of the quadtree bitmap (FIG. 6D).

FIG. 7A shows how the original bitmap LX12 is reconstructed from the reconstructed LRX12 (FIG. 7B) by reversing the row XOR operation on LRX12 during the decoding process.

FIG. 7B shows the fully reconstructed LRX12 bit map after the quadtree decoding process is performed.

FIG. 8A shows the reconstructed layer LX12 (FIG. 8A) in connection with how it is used to reconstruct original layer L2 (FIG. 8C) by XORing LX12 with a previous layer L1 (FIG. 8B)

FIG. 8B shows an exemplary previous bitmap layer L1 to illustrate the reconstruction process.

FIG. 8C shows the resulting reconstructed bitmap layer L2.

### DETAILED DESCRIPTION

As discussed above, the input to the compression process is a series of bitmap images that each represent a two-dimensional cross section of a layer of an object to be printed. The bit maps are typically 1 bit per pixel, defining whether material should be deposited by the 3D printer at that pixel (e.g., bit 1) or not (bit 0). However, the methods and systems disclosed herein may equally well be applied to printers that provide grey scale printing, in which case there could be two or more bits per pixel.

In an exemplary 3D printer, the uncompressed layer bitmaps for an object may, by way of example, have 32K pixels in the X direction and 16K pixels in the Y direction, which, assuming 1 bit per pixel, results in 64 MB of raw data per layer. In an exemplary embodiment of an object being built from 6000 layers, the total amount of raw data per print job would, in that case, be 384 GB, and 768 GB if a pixel is defined by 2 bits of data.

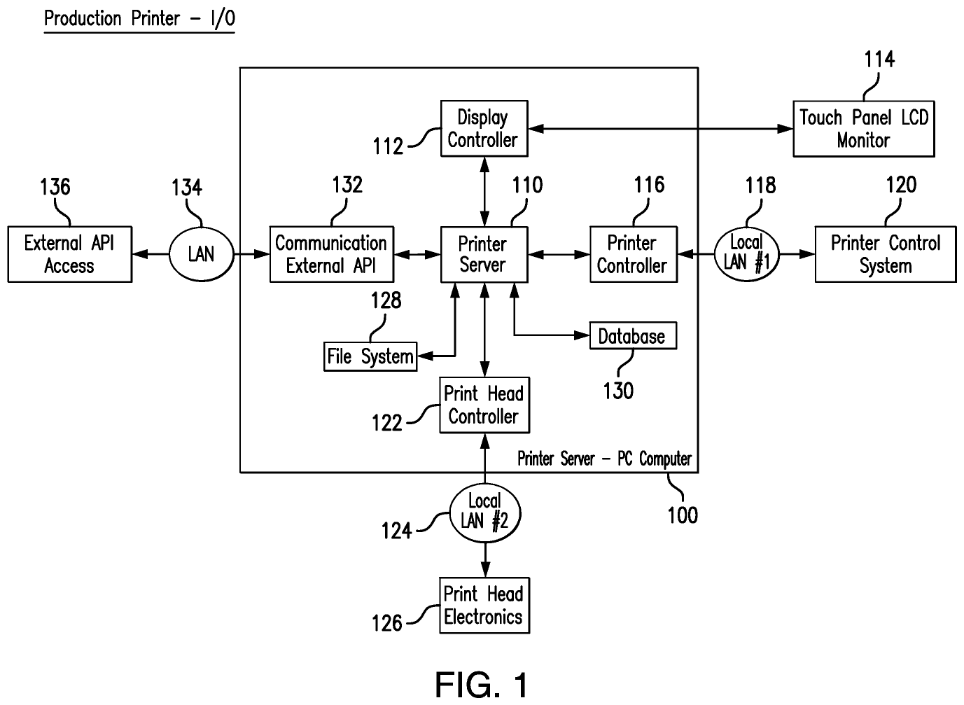

Before further describing methods for compressing and decompressing such 3D layer data in accordance with this disclosure, FIG. 1 provides a block diagram showing an exemplary system embodiment of a typical 3D printer system that may be used to implement such methods.

With reference to FIG. 1, the 3D printer system may include a computing device 100 that may be connected to various other computing devices and components of the 3D printer. As shown, the computing device 100 may include a printer server 110 that is coupled to controllers, communication devices and computer memories that store information regarding print jobs, 3d layer data for one or more print jobs, and operating program instructions for the 3D printer, such as instructions for moving and operating the print heads and other printer components to enable 3D printing.

In the exemplary embodiment of FIG. 1, the printer server 110 is shown as being coupled to a display controller 112 that communicates with a monitor 114. This monitor may be used by an operator to input instructions to and otherwise control the 3D printer. A printer controller 116 is shown coupled through a local area network or LAN 118 to a printer control system 120 that exercises overall control over the 3D printer, including the sequencing and movement of print heads, etc.

In the FIG. 1 embodiment, the printer server 110 is also shown to be coupled to a print head controller 122 that communicates through a LAN 124 to print head electronics 126 that communicates operational parameters to one or more print heads in the 3D printer.

One or more memories are included in the FIG. 1 system for storing information about the 3D object to be printed, as well as other parameters necessary to operate the 3D printer. As shown in FIG. 1, the printer server 110 is coupled to a file system 128 that includes one or more memory devices that may be used to store 3D layer data, either in uncompressed format or after the 3D layer data has been compressed in accordance with this disclosure, which the printer server 110 can communicate at the appropriate time to the print head electronics 126 via the local LAN 124.

In the exemplary embodiment of FIG. 1, a database memory 130 is shown coupled to the printer server 110 for storing print jobs and other information necessary to the operation of the 3D printer. As further shown in FIG. 1, a communication controller 132 may be provided for communicating to other devices over an external LAN 134, by which external APIs may be executed to permit remote monitoring of various operating data that is collected by the 3D printer for assisting in remote printer diagnostics, etc.

While FIG. 1 is provided as an exemplary embodiment showing basic system components and modules of a 3D printer, workers of skill in this art will appreciate that many variations in such system details are possible for implementation of the disclosed invention.

In an exemplary embodiment, uncompressed 3d layer data for one or more print jobs may be compressed off site and transmitted to the 3D printer over an external LAN (e.g., over LAN 134 of FIG. 1) for storage in the 3D printer system (e.g., in file system 128 of FIG. 1). In this case the off-site facility may include or have access to a non-volatile computer storage medium that stores a program which implements the encoding (or compression) steps disclosed herein on the 3D layer data prior to transmission to the 3D printer system. Alternatively, compressed layer data for a 3D object to be printed may be provided to the 3D printer system on a non-volatile computer medium that is read directly by the 3D printer system.

In either case, to process such compressed data, the 3D printer system preferably include a non-volatile computer medium that stores a program for implementing the decoding (or decompression) steps disclosed herein. This permits the 3D printer system to decompress the 3D layer data for an object to be printed, and provide it in the appropriate sequence and timing, as may be needed by the 3D printer to print the desired object.

In particular, when an operator of the 3D printer selects a particular print job having parameters stored in database 130, the compressed 3D layer data corresponding to that print job may be retrieved from the file system 128 (or another memory location where it may be stored) and decompressed, e.g., by the printer server 110 in accordance with the steps disclosed herein so that the decompressed data may be supplied as needed when the print job is being executed.

For this purpose, in the exemplary system embodiment shown in FIG. 1, the file system 128, database 130 or printer server 110 may each include a non-transient computer readable medium for storing instructions executable by the printer server 110, for performing the data decompression steps disclosed herein. Such non-transient computer readable medium may be a computer memory in the form of a magnetic disk drive, an optical drive, a flash drive, or any other computer memory device capable of storing program instructions for execution.

As used herein, the term “non-transient” is intended to describe a computer-readable storage medium that excludes propagating electromagnetic signals, but which may otherwise include storage devices such as volatile memory (e.g. RAM) that does not necessary store information permanently. Program instructions and data stored on a tangible computer-accessible storage medium in non-transitory form may further be transmitted by transmission media or signals such as electrical, electromagnetic, or digital signals, which may be conveyed via a communication medium such as a network and/or a wireless link.

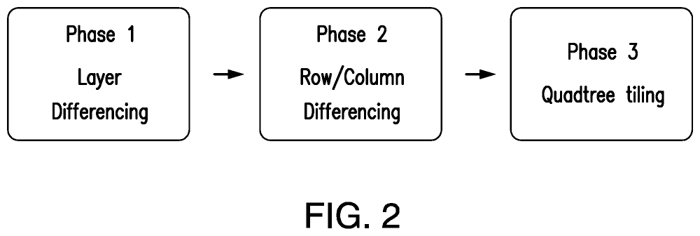

The disclosed methods for compressing the 3D layer data may be modelled in three basic phases, which are outlined in FIG. 2. In Phase 1, the differences between the current layer and the previous layer are computed and encoded as the bitwise XOR (i.e., the exclusive OR) of the two bitmaps. The bitwise XOR operation may be denoted in the following description by either the symbol ⊕ or simply XOR. The bitwise XOR operation produces bit 0 if the two XOR-ed bits are the same (either both 1's or both 0's) and bit 1 if the two XOR-ed bits are different. Hence A XOR B (A⊕B) has a value of 1, if and only if A and B are different. Since adjacent layers are very similar, with the object profiles mostly overlapping (often due to the need for physical support structures), Phase 1 dramatically reduces the numbers of l's in the XOR-ed layer data, and creates a very sparse stream of bytes having many 0's.

Referring again to FIG. 2, in Phase 2, for each differential XORed image obtained from Phase 1, the row and/or column differences are computed as the bitwise XOR between each row (and/or column) and the previous one. This row and/or column differencing further reduces the number of 1's in the resultant output bitmap.

In practice, it may not be necessary to difference both rows and columns during Phase 2. For example, the inventor has empirically determined that differencing of only the adjacent rows may often suffice and that subsequent column differencing may only provide a relatively small amount of compression that may be insufficient to justify the additional processing time (which would typically double the processing time for Phase 2).

Significantly, the use of bitwise XOR operations for computing and encoding differences in Phases 1 and 2, allows one to change the order of the two phases for convenience of the implementation (since A⊕B is the same as B⊕A).

As further depicted in FIG. 2, in Phase 3, a quadtree tiling approach is used to further encode and provide additional data compression, by taking into account the presence of clustering regularities in the 3D layer data that correspond to clusters of regions where material is to be deposited and clusters of regions having no material.

By way of example, in a first level quadtree, the quadtree tiling method will first tile the 2D bitmap for each layer into 2×2 pixel squares. For each such 4 pixel square, a “representative” single pixel is created that represents the 2×2 square. This will become more evident in the following description.

In accordance with the methods and systems disclosed herein for 1 or 2 bits/pixel layer data, the value of the “representative” pixel in each tile is determined by applying the OR logical operator to the 4 pixels of the tile. Hence, this single pixel is 0 if all 4 pixels of the original 2×2 tile are all zeros, and 1 if any one of the 4 pixels is 1. The result of this step is a 4 times smaller (or coarse grained) bitmap compared to the original bitmap showing regions that have at least one non-zero pixel.

This process may be iterated by applying the same 2×2 tiling process to this “representative” smaller image, yielding an overall 16 times smaller “representative” bitmap. The coarse graining OR step may be similarly applied to each new representative bitmap, successively reducing the new bitmap size by a factor 4.

The reversible raw output of the entire quadtree iterative process is a 4-way tree data structure, with each parent node branching into 4 child nodes. Each node holds, besides the links to its child nodes, the pixel value of the node.

The raw 4-way tree may then be reduced in size by pruning the subtree descending from every node that has a (coarse grained) pixel value of 0, since in that case the OR operator-based coarse graining implies that all descendants of this node will also have a pixel value of 0.

For well-clustered images, this quadtree tiling procedure effectively tiles the image into variable size squares that separate the image into empty regions (pixel value equals 0) and non-empty regions (pixel value equals non-zero).

In practice, the depth of the quadtree hierarchy may be determined by taking into account a tradeoff between the amount of computation and compression processing speed. For layer data encountered in common print jobs on an exemplary 3D printer, the inventor has empirically found that a preferable tradeoff may typically be met by 3-4 levels of quadtree processing (i.e. 8×8 or 16×16 tiling).

As depicted in FIG. 2, the input to the quadtree tiling phase (Phase 3) is the output of the differential bitmaps resulting from Phases 1 and 2. Hence, the quadtree tiling phase operates on very sparse and well-clustered bitmaps, which are precisely the type of data for which quadtree tiling is useful to provide further compression.

The output of the quadtree phase is a top level quadtree bitmap plus an array of non-zero tiles (e.g. 8×8 or 16×16 pixels per tile) showing the order of pixels with value 1 (or non-zero value for multibit pixels) encountered in the coarse-grained bitmap as it is scanned from left to right.

The quadtree tiles having all pixels 0 are implied and hence do not have to be transmitted. Since they all have value 0 for all of their pixels, the decoder can regenerate them without requiring any additional information other than the quadtree bitmap.

Optionally, XOR-based bitwise differencing as described above may be applied to quadtree bitmaps for successive layers (analogous to layer differences). This further step may be useful for vary large images with regular, repetitive parts.

Other optional variations for this phase of processing may include selection of different numbers of quadtree hierarchy levels, selection of the left or right scan order, using tree encoding data types, packaging of the output components (the quadtree bitmaps and the tiles), and the like.

Although not shown in FIG. 2, after quadtree coding, the modeling phase of the compression process may be completed by applying conventional entropy coding to the output of the quadtree compression process. Entropy coding would generally be used as the final stage of the layer data compression (the first stage being data modeling). The entropy coder receives two components from Phase 3: (a) the quadtree bitmap and (b) quadtree tiles corresponding to those tiles having non-zero pixels in the quadtree bitmap.

Since these two components are of a distinct nature, with very different densities and patterns of 1's in their one-dimensional data streams, the two components may be encoded separately.

The entropy encoding empirically found to work well with such sparse, well-clustered one dimensional data, is the BZIP algorithm. This coder, which is based on the Burrows-Wheeler Transform (BWT), can be implemented using the open source library “libbz2.”

The compressed 3D layer data that may be sent to the 3D printer will generally consist of thousands of layers that have been efficiently encoded to take into account the 2D and 3D regularities present in such data, in accordance with the disclosed methods and systems. Advantageously, the compressed layer data for each such job containing thousands of layers may be packaged into an archive file for each job.

Each compressed layer resulting from the above three phases of compression followed by entropy coding may form a single variable size record in the archive file. A small archive header (e.g., 16 bytes) may include basic information such as the X and Y dimensions, the number of bits per pixel, an image header common to all images in the archive, as well as the number of images in the archive, the maximum buffer sizes for the compressed image records and the maximum expanded size for the quadtree tile components of each image record (i.e., the compressed quadtree bitmap and the tile arrays). The latter information is useful since it allows the decoder to allocate the input and intermediate output buffers only once.

The image records may be packed sequentially back-to-back after the archive header and the common image header. Each record may be prefixed by the record size (single 4-byte integer) followed by the compressed quadtree bitmap and tile array. It is not necessary to transmit the sizes of these two separately compressed components to the decoder since the BZIP output is self-terminating. In other words, the BZIP decoder is provided only the total size of the combined image record, and it terminates automatically when it encounters the end of the first compressed component, providing the output size and the size of the input consumed. A second call may then be issued to the BZIP decoder with the remaining compressed record data to expand the second component.

Further, for the convenience of and flexibility of archive creation and use, special sentinel records may be supported (controlled by library APIs that may be used by clients). The sentinel records are compressed image records that do not difference a layer with the previous layer. The usefulness of such records is that they allow decoding of images that follow the sentinel record without having to decode the entire archive from the beginning. They also allow building of an archive in separate runs, by appending a sentinel record at the start of each new batch, without the need to decode an entire archive up to the new append point (in order to provide the previous layer for layer differencing of the first appended image).

In order to distinguish sentinel records from regular layer-differenced records, the archiver may store the record length of the sentinel record as -RecordLength (i.e. as a negative integer), which signals the decoder to skip the layer differencing step.

Having now outlined the basic steps of the compression (encoding) process, the decoding process for decompressing the 3D layer back to its original data proceeds in the reverse order of the encoding. After reading the archive header and decoding the compressed common image header, the decoder will fetch compressed image records sequentially. This action may be initiated via library API calls.

For each compressed image record, decoding may be performed by the following sequence of steps:

1) Decompress (via the BZIP decoder) the quadtree bitmap from the record. The BZIP decoder returns the decoded bitmap, plus the amount of compressed data consumed for the decoding.
2) Decompress the rest of the compressed record to reconstruct the quadtree tiles array.
3) Initialize the output image bitmap with 0 pixels
4) Scan the quadtree bitmap (loop in y, then x coordinates) and whenever a non-zero pixel is encountered fetch the next decompressed tile from the tile array and insert it at the location ximg, yimg of the output image. The variables x, y are the loop counters for quadtree bitmap scan while x-img, yimg are output image coordinates, e.g. ximg=8*x, yimg=8*y for 8×8 tiles).
5) Un-difference the scan rows (and/or columns, depending on differencing type used for the archive). The un-differencing may be done by performing XOR operations in reverse order of the differencing performed by the encoder. For example if the encoder XOR-s the 2nd row into 1st, 3rd row into 2nd, . . . the n-the row into (n−1) row, then the decoder will XOR the n-th row into (n−1) row, n−1 row into n−2 row, . . . , 3rd row into 2nd second, and 2nd row into 1st row.
6) If the image is the first record in the archive or a sentinel record, the image is returned to the caller (after prepending the common image header) and retained also by the decoder as the “previous layer”.
7) Otherwise, the image is a layer-differenced image. Hence it is additionally XOR-ed with the “previous layer” to obtain the original image. The common image header is prepended and the complete image is returned to the caller. The newly decoded image is then retained as the “previous layer” for the next layer.

Library routines may also provide options for formatting the output image, as, for example, a raw TIFF or LZW-encoded TIFF image. This option can be applied to the decoded images before they are returned to the caller.

In practical implementations of a decoder constructed according to the methods and systems disclosed herein, and for performance reasons, the conceptually distinct un-differencing steps 5 and 7 described above may be combined in a single pass over the image rather than as separate passes (as described above in conceptual steps 5 and 7). In such case, each output image pixel would be handled only once and XOR-ed either with a corresponding pixel from the previous row (step 5) or with two pixels, one from the previous row and another from the previous layer (step 5, 7).

Still further, in some cases, pseudo-random dithering may be used to simulate the effect of grey shades using black and white (i.e., 0 and 1) pixels. Since such pseudo-random, noise-like transformation of layer images will tend to superficially increase the apparent differences between layers, it is preferable the encoder to perform row and layer differencing on un-dithered bitmaps. Any required dithering may however be applied subsequently by the decoder on the extracted un-dithered images.

Alternatively, dithering effects may be modeled in the encoder. While this may be more flexible in allowing variations of dithering type for different regions of the image, is more complex and costlier on machine resources (e.g., in memory and processing times).

The following detailed description provides a specific illustrative example of how the encoding of two layers, L1 and L2, would be done in accordance with the methods described above.

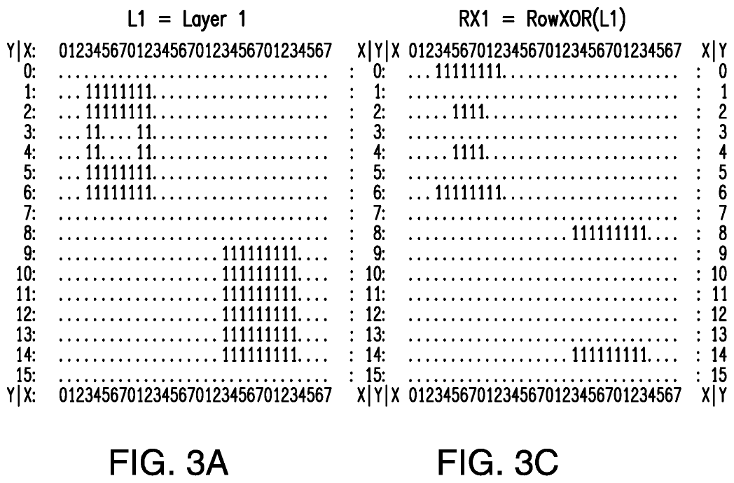

For purposes this illustrative example, and as shown in the example of FIG. 3 et seq., the layer bitmaps are assumed to be of small size, i.e., 32 pixels in the X direction and 16 pixels in the Y direction. It is understood however, that the actual layer images used by a 3D printer are typically 1000 times larger in each dimension, yielding a 1000×1000=million times larger bitmaps than the ones shown in the following illustrative example.

Further, the pixels in this illustrative example (e.g., FIG. 3) have 1 bit per pixel (pixel values are 0 or 1). However it is understood that pixels represented by 2 or more bits may be processed similarly in by performing the XOR operations in a bitwise manner. Further, for display clarity, the layers shown in FIG. 2 et seq. use a ‘.’ symbol to designate a pixel value of 0. Note also that the X and Y coordinate designations are shown on all four sides for each layer to allow easy tracking of operations from one image to another.

FIGS. 3A and 3B respectively show layer images for layer 1 (L1) and layer 2 (L2) of an object to be 3D printed. To the right of each layer image L1 and L2, is the corresponding Row-XOR-ed image, i.e. the resultant image when the rows are XOR-ed using the following sequence of operations:

Row[0] XOR Row[1] →Row[0]

Row[1] XOR Row[2]→Row[1]

Row[2] XOR Row[3] →Row[2], etc.

The bitmap that results from XORing the rows of L1 is denoted as RX1 and is shown in FIG. 3C; while the image that results from XORing the rows of layer L2 is denoted as RX2, and is shown in FIG. 3D.

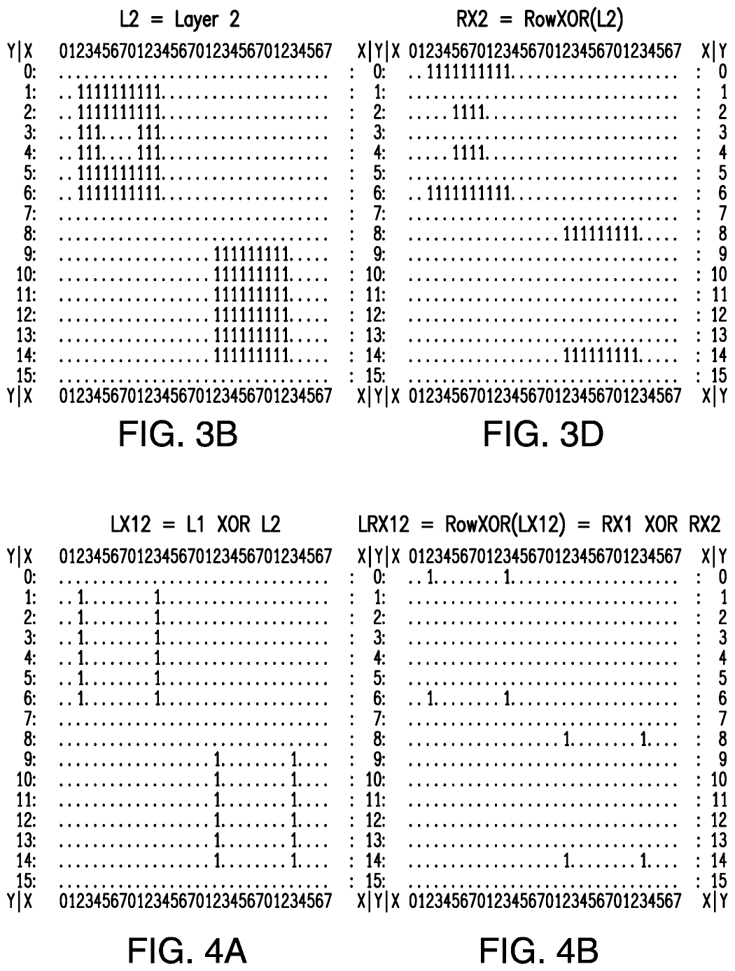

A third pair of images in FIG. 4A, B shows, on the left-hand side a bitmap LX12 (FIG. 4A), which results from XORing each corresponding row of L1 with L2. This is illustrative of the output of Phase 1. Its Row-XOR-ed counterpart LRX12 is shown in FIG. 4B, and is illustrative of the final output of combined Phase 1 and Phase 2 of the encoder processing. Note that the bitmap LRX12 has many more zeroes, than either L1 or L2 or LX12, which results in Phases 1 and 2 providing very high compression of the original 3D layer data.

Also, note that in the case of the first layer L1, which does not have a “previous layer” to difference it with, the final output of the Phase 1+2 processing of L1 is only its Row-XOR-ed bitmap, RX1.

As evident from FIGS. 3 and 4, due to the commutative and associative properties of the XOR operator, the final result of Phases 1 and 2 (i.e., the image LRX12) can be obtained via two different paths. In a first path, the two layer bitmaps L1 and L2 may be XORed to generate LX12, which may then be row XORed to generate LRX12. Alternatively, the same result can be obtained by first row XORing L1 to obtain RX1, row XORing L2 to obtain RX2, and then XORing RX1 with RX2 to obtain LRX12. This can be verified by examining the bitmaps shown in FIGS. 3 and 4.

For processing efficiency, the latter path may be advantageously chosen since it reduces the storage requirements and allows combining of layer and row XOR operations into a single pass over each input image. Namely, when layer 2 is being processed, the encoder can simultaneously XORs rows of L2 and then XORs the result with the already Row-XOR-ed corresponding pixels of the previous layer RX1, to obtain pixels of LRX12.

As discussed above, in Phase 3, the output bitmap LRX12 (FIG. 4B) resulting from Phases 1 and 2 is further compressed by being tiled by the quadtree tiling approach. Hence, in our illustrative example, the bitmaps being tiled are RX1 for layer L1, the first layer; and LRX12 for L2, and analogously for all higher layers.

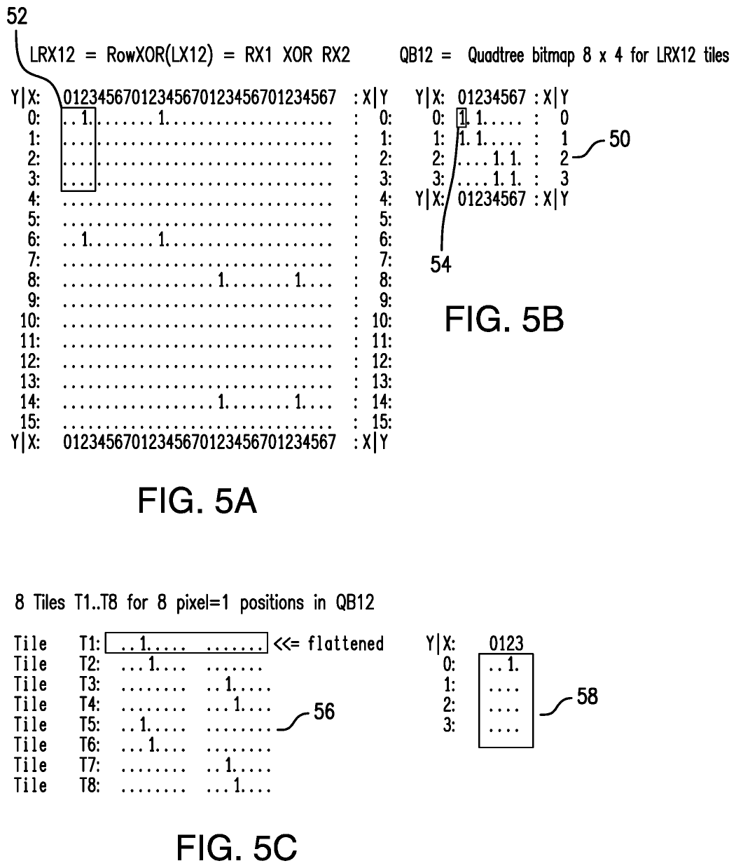

As shown in FIG. 5A, for the purpose of our illustrative example, we use a 2 level quadtree tiling, which yields tiles having 4×4=16 pixels per tile. This can be readily expanded to 3 or 4 level quadtrees, if desired, which will would yield tiles with 8×8=64 or 16×16=256 pixels per tile, respectively).

Since the images in our illustrative example are of size 32×16 pixels, the 4×4 tiling will produce an 8×4 pixel quadtree bitmap (32/4×16/4=8×4), plus a variably-sized array of 4×4 tiles, for each tile that is represented by a pixel of value 1 in the quadtree bitmap.

The tiling procedure is illustrated in FIG. 5A for the illustrative layer 2 output of Phases 1 and 2, i.e., the bitmap LRX12.

As shown in FIG. 5A, the LRX12 bitmap (reproduced from FIG. 4B) is shown as being tiled into 4×4=16 pixel squares (see, e.g., the illustrative square in the upper left hand corner of LRX12 indicated by reference numeral 52. For each such square by which the LRX12 bitmap is tiled, the representative quadtree bitmap pixel is set to 0 if all 16 pixels are 0, and to 1 if any of the 16 tile pixels is 1. In FIG. 5B, the resulting 8×4 quadtree bitmap QB12 is shown to the right of the LRX12 bitmap as indicated by reference number 50. As indicated, tile 52 of LRX12 maps into the upper left pixel=1 (reference numeral 54) of the QB12 bitmap 50, since tile 52 contains at least one pixel of value 1.

In this example, note that only 8 out of the 32 quadtree pixels in QB12 50 have a value of 1. Hence, Phase 3 also produces an array 56 showing the content of those 8 tiles T1 . . . T8, each tile containing 4×4=16 pixels as shown in FIG. 5C. In FIG. 5C, the eight 4×4 tile bitmaps are shown flattened into a 1-D format, except for tile T1 which is also shown in 2-D form at reference number 58. (It corresponds to the upper left 4×4 tile in LRX12). As evident, the tile array 56 shows the pixel locations that contain a bit 1, for each of the 8 tiles that QB12 bitmap 50 identifies as having at least one non-zero bit.

Accordingly, the final output of Phase 3 for layer 2 provides two objects: (1) the QB12 bitmap and (2) the array T[8]=Array(T1 . . . T8) representing the content of the 8 tiles that have at least one non-zero bit (i.e. pixel value 1), and showing the position within the tile of such non-zero bits.

As a final step in the encoding process, each of these two objects is then passed separately to a conventional BZIP2 encoder, yielding two BZIP2 compressed chunks which are the final output for Layer 2 that may be saved to the print job archive.

Having provided an illustrative example of the encoding process for compressing the 3D layer data, the following example illustrates the decoding process for reversing that compression. As exemplary input to the decoder, we use the compressed data of Layer 2 produced in the encoding example described above.

During the decoding process, the layers are decoded sequentially (1, 2, 3, etc.) since that is typically the order in which layer data is provided to a controller in the 3D printer that controls the print head. Therefore, we will already have available expanded Layer 1 data, the bitmaps L1 and RX1 as described in the encoder example provided above and shown in FIGS. 3A and 3C.

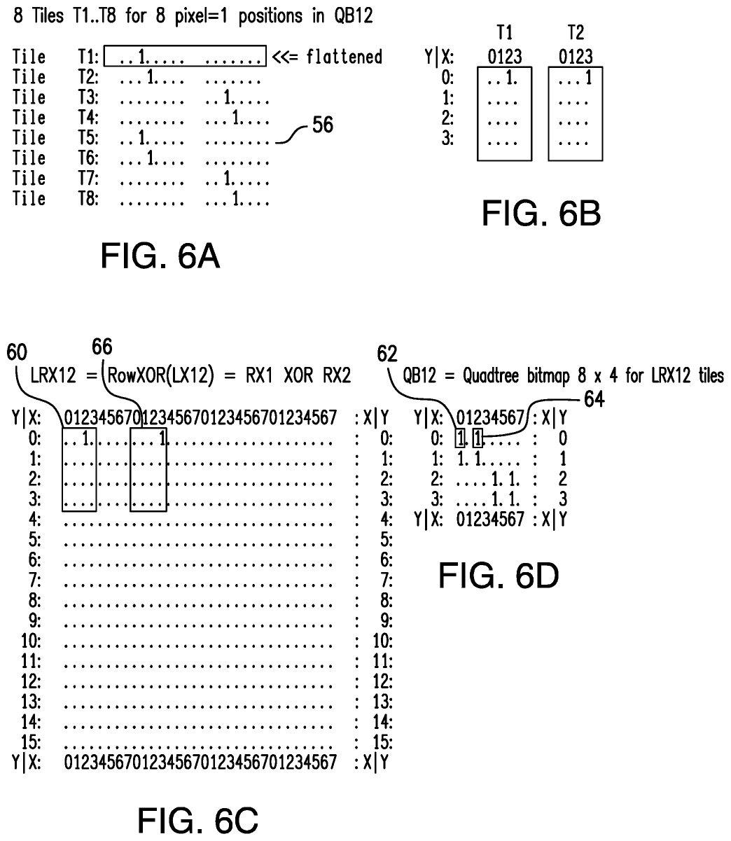

In a first Step 1, the decoder reads the compressed record for Layer 2 and decompresses the record (by using the BZIP decoder), to obtain the quadtree bitmap QB12 from the record. The BZIP decoder returns the decoded bitmap data QB12, plus the amount of compressed data consumed (i.e. the size of the first compressed chunk). In our illustrative decoding example, this decoded quadtree bitmap QB12 is the 4×8 bitmap shown in FIG. 6D.

In Step 2 the decoder (by again using the BZIP decoder) decompresses the rest of the compressed Layer 2 record (i.e. the second compressed chunk), to obtain the quadtree tile array T[8]=Array(T1 . . . T8). In our illustrative decoding example, the resulting quadtree tile array is shown in flattened format in FIG. 6A; and the first two tiles thereof, i.e., T1 and T2, are shown in bitmap format in FIG. 6B. As evident, the complete output after the BZIP decompression consists of the quadtree QB12 bitmap (FIG. 6D) and the array of 8 tiles T1 . . . T8 (FIG. 6A)

In Step 3, the decoder reconstructs the bitmap LRX12 by starting with an empty bitmap (all pixels are 0). To do so, the QB12 quadtree bitmap is scanned from left to right, starting at the top left and proceeding in a zig-zag raster scan to the bottom right. In the exemplary case discussed herein where the tiles have 4×4 bits, a destination tile pointer in the LRX12 bitmap is advanced 4 pixels in a corresponding zig-zag scan that starts at the top left corner of the LRX12 bitmap for each advance of 1 pixel in the QB12. If the current QB12 pixel is 1, then the next tile from the tile array T[8] is retrieved and copied into the LRX12 bitmap at the current location of the destination tile pointer.

This method is illustrated in FIG. 6C, which shows that the tile T1 (reference numeral 60) is retrieved and placed in the upper left-hand corner of FIG. 6c, when the first pixel with a value 1 (reference numeral 62) is retrieved from QB12 (i.e., when the first pixel in the upper left corner of QB12 is encountered). The second pixel=1 in QB12 (reference numeral 64), which is the third pixel of the first row in QB12, causes retrieval of the second tile T2 from the tile array T[8], which is then copied at the current destination tile pointer in LRX12, as further illustrated in FIG. 6C at reference numeral 66.

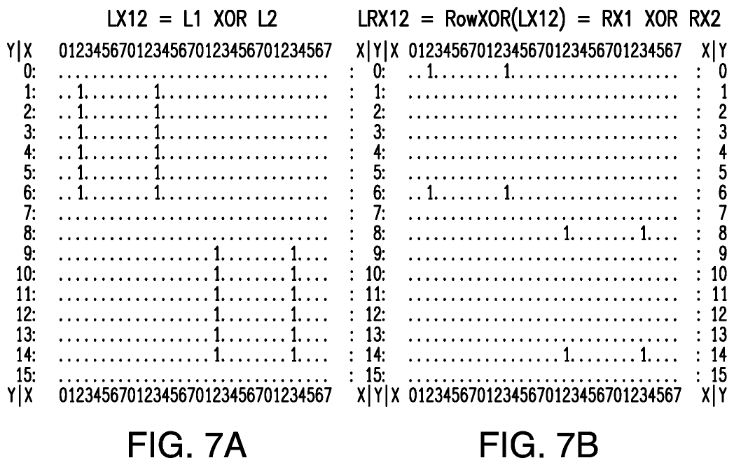

This process continues until all tiles from tile array T[8] are retrieved and copied into the LRX12 bitmap, which results in reconstruction of the original LRX12 bitmap (as shown in FIG. 7B).

In Step 4, original bitmap LX12 (see, FIG. 7A) is reconstructed from LRX12 by reversing the row XOR operation on LRX12 as follows. (In the following notation, N is the number of scan rows in the bitmap, with the last row having index N−1 (e.g. for N=16 rows, the last row has index 15):

Row[N−1] XOR Row[N−2] →Row[N−2]

Row[N−2] XOR Row[N−3] →Row[N−3]

. . .

Row[2] XOR Row[1]→Row[1]

Row[1] XOR Row[0] →Row[0]

The resulting reconstructed LX12 bitmap is shown in FIG. 7A. If this is the first layer, the decoding is done, and its output is Layer 1 (the original bitmap LX12 shown in FIG. 4A). Otherwise, the decoder proceeds to step 5, to reverse the XOR operation on the layers originally performed by the encoder.

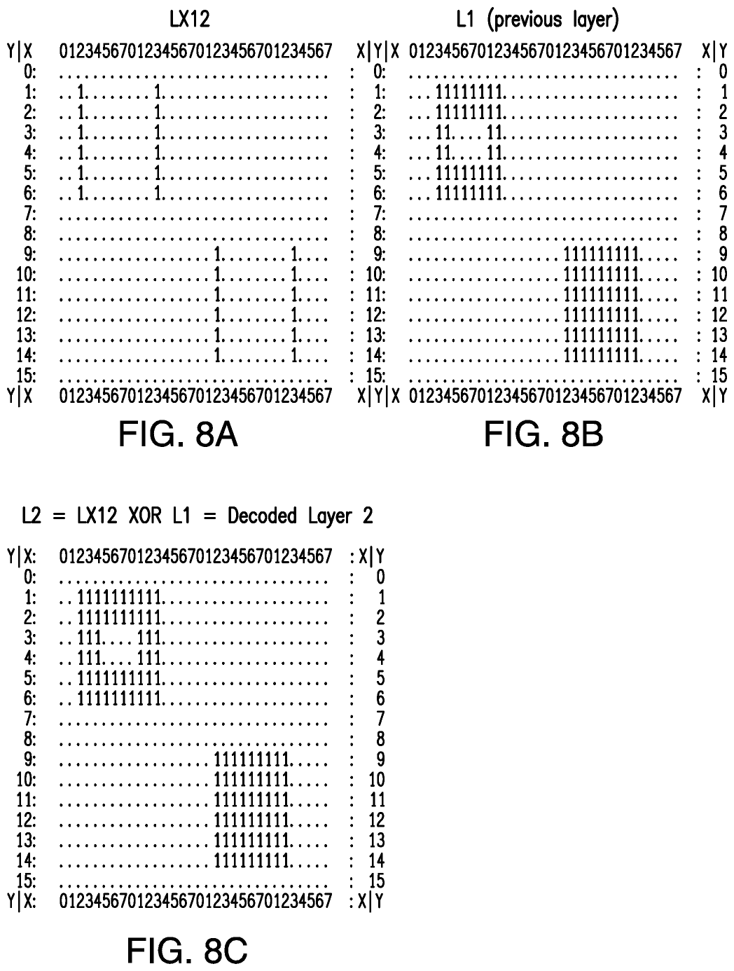

In Step 5, original Layer 2 (L2) is reconstructed from the previous layer L1 and the now reconstructed LX12 bitmap by first noting (from the above discussion of the encoder example) that LX12=L1 XOR L2. Using the properties of the XOR operator, L2=LX12 XOR L1, where L1 is the “previous layer” (retained by decoder after Layer 1 was decoded). The result, using the bitmap L1 from the encoder example as the “previous layer” is shown in FIGS. 8A-8C. In particular, reconstructed layer LX12 (FIG. 8A) is XORed with previous layer L1 (FIG. 8B) to reconstruct original layer L2 (FIG. 8C).

The foregoing sequence of steps may be repeated to reconstruct all of the other original layers required by the 3D printer to print the object.

As evident from this disclosure and the related Figures, the foregoing steps performed by the decoder on all encoded layers, transforms the encoded layers back to their original form, and reverses the original compression performed by the encoder in a lossless manner.

Now that exemplary embodiments of the present disclosure have been shown and described in detail, various modifications and improvements thereon will become readily apparent to those skilled in the art, all of which are intended to be covered by the following

What is claimed:

1. A method for reducing the amount of data required by a 3D printer to print an object, said data including a plurality of bitmap layers each comprising a 2D array of pixels representing a cross sectional layer of the object, wherein said method includes the steps of:
a) forming a first differential bitmap representing differences between corresponding pixels of a bitmap layer and an adjacent bitmap layer; and
b) forming a second differential bitmap representing the differences between corresponding pixels in adjacent rows or columns of the first differential bitmap.

2. The method of claim 1, wherein the first differential bitmap is formed by computing a bitwise XOR between corresponding pixels of the bitmap layer and the adjacent bitmap layer.

3. The method of claim 1, wherein the second differential bitmap is formed by computing a bitwise XOR operation between corresponding pixels in adjacent rows or columns of the first differential bitmap.

4. The method of claim 3, further comprising the step of quadtree tiling the second differential bitmap to form a quadtree bitmap and a quadtree tile array.

5. The method of claim 4, wherein the quadtree tile array includes pixel values of tiles having one or more non-zero pixels.

6. The method of claim 4 wherein the quadtree bitmap represents tiles having one or more non-zero pixels by a pixel of value 1, and tiles having all zero pixels by a pixel value of 0.

7. The method of claim 4 wherein the quadtree tile array and quadtree bit map are entropy coded.

8. An encoding method for reducing the amount of data required by a 3D printer to print an object, said data including a plurality of bitmap layers, each comprising a 2D array of pixels representing a cross sectional layer of the object, wherein said method includes the steps of:
a) forming a first differential bitmap representing the differences between adjacent rows of a first bitmap layer;
b) forming a second differential bitmap representing the differences between adjacent rows of a second bitmap layer; and
c) forming a third differential bitmap representing the differences between the first and second differential bitmaps.

9. The method of claim 8 wherein the first differential bitmap layer is formed by computing the bitwise XOR between corresponding pixels in adjacent rows of the first bitmap layer.

10. The method of claim 8 wherein the second differential bitmap layer is formed by computing the bitwise XOR between corresponding pixels in adjacent rows of the second bitmap layer.

11. The method of claim 8 wherein the third differential bitmap layer is formed by computing the bitwise XOR between corresponding pixels of the first and second differential bitmaps.

12. The method of claim 8, further comprising the steps of quadtree tiling the third differential bitmap to form a quadtree bitmap and a quadtree tile array.

13. The method of claim 12, wherein the quadtree bitmap and quadtree tile array are entropy coded.

14. The method of claim 1, further comprising the step of forming a third differential bitmap representing the differences between adjacent columns of the first differential bitmap layer.

15. A method of compressing data corresponding to a plurality of bitmap layers each comprising a 2D array of pixels, comprising the steps of:
a) forming a first differential bitmap representing differences between adjacent bitmap layers,
b) forming a second differential bitmap representing differences between adjacent rows or columns of the first differential bitmap, and
c) quadtree tiling the second differential bitmap to form a quadtree bitmap and a quadtree tile array.

16. The method of claim 15, further including the step of entropy coding the quadtree tile array and quadtree bit map.

17. A method of compressing data corresponding to a plurality of bitmap layers each comprising a 2D array of pixels, comprising the steps of:
a) forming a first differential bitmap representing differences between adjacent rows of a first bitmap layer,
b) forming a second differential bitmap representing differences between adjacent rows of a second bitmap layer,
c) forming a third differential bitmap representing the differences between the first and second differential bitmaps, and
d) quadtree tiling the second differential bitmap to form a quadtree bitmap and a quadtree tile array.

18. The method of claim 17, further including the step of entropy coding the quadtree tile array and quadtree bit map.

19. A method of decompressing data compressed in accordance with claim 16, said method decompressing a bitmap layer back to its original content by performing the steps of:
a) reversing the entropy coding to reconstruct the quadtree tile array and quadtree bit map;
b) using the reconstructed quadtree tile array and quadtree bit map to reconstruct the second differential bitmap,
c) using the second differential bitmap to reconstruct the first differential bitmap; and
d) using the first and second differential bitmaps to reconstruct the bitmap layer.

20. A non-transitory computer-readable medium that stores program instructions capable of being executed by a processor to perform the steps of claim 15.

21. A non-transitory computer-readable medium that stores program instructions capable of being executed by a processor to perform the steps of claim 19.
